(19) United States
(12) Patent Application Publication
(10) Pub. No.: US 2005/0052376 A1
(43) Pub. Date: Mar. 10, 2005

(54) Method and apparatus for light emitting devices based display

(76) Inventor: Shiraz M. Shivji, Saratoga, CA (US)

Correspondence Address: HEIMLICH LAW, 5952 DIAL WAY, SAN JOSE, CA, 95129, US

(21) Appl. No.: 10/810,300

(22) Filed: Mar. 26, 2004

Related U.S. Application Data
(60) Provisional application No. 60/496,323, filed on Aug. 19, 2003.

(51) Int. Cl. G09G 3/32

(52) U.S. Cl. 345/82

(57) ABSTRACT

A method and apparatus for a light emitting devices based display have been disclosed.

### RELATED APPLICATION

This patent application claims priority of U.S. Provisional Application Ser. No. 60/496,323 filed Aug. 19, 2003 titled “Method and Apparatus for Light Emitting Devices Based Display”, which is by the same inventor as this application and which is hereby incorporated herein by reference.

### FIELD OF THE INVENTION

The present invention pertains to displays. More particularly, the present invention relates to a method and apparatus for a light emitting devices based display.

### BACKGROUND OF THE INVENTION

Displays are an integral part of conveying information. The display of information in a visual format is often the most effective way of communicating information. The need for displays of all sizes from very small (for example, cell phones) to large displays (for example, stadium replays) is a continuing quest. Additionally, in some applications, for example, cell phones, an added requirement may be low power consumption by the display. Additionally, a projection display may be needed. This may present a problem.

An electronic display is one of the most common forms of output device and is one of the best means of conveying information (visually) to human beings. Electronic displays thus find use in instrumentation, computers, entertainment and other fields. Portable devices such as laptops, cellular phones, and PDAs (Personal Digital Assistants) are widely used and utilize various display technologies. At present, LCD displays are commonly used. Most users prefer to have as high a resolution display as possible but this often leads to larger units such as the 15″ and 17″ LCD screens now popular in laptop computers. It may be beneficial to have a high resolution readable device that is small in size. One approach to achieving a large display is through optically magnifying a compact virtual image electronic display. One such display is referred to as a “head-mounted display” however, this display may be cumbersome to use as it is attached to the user.

A small compact projection display that projects a real image may be desirable. At present there are several large cumbersome high power consuming projection devices in the marketplace. These devices typically use spatial light modulators such as a DMD (Digital Micromirror Device) or a Liquid Crystal Light Valve or a reflective LCOS (Liquid Crystal on Semiconductor) array device. DMD and LCD type projectors use a high intensity lamp that burns at a constant brightness. A 250 W bulb is typically used. Thus, the final device produced is cumbersome, bulky, uses a lot of power, and needs a significant amount of cooling. Another approach is to use blue, green and red light emitting diodes as the light source with a spatial light modulator. It may be difficult, however, to produce the required brightness.

Another commonly used projection display technology uses cathode ray tubes (CRTs). These displays are large and bulky since they typically use three very bright CRTs focused through a single lens or three lenses to project an image. CRT based projection systems are used for projection TV systems and are not very portable.

Display projection systems based on DMDs, LCDs, or LCOSs are typically more portable but are still bulky. A typical “portable” unit measures 1.9″×9″×7″ in size, weighs more than a kilogram, and consumes more than 300 Watts. They are typically designed to project a 7.5 foot diagonal image (which covers 27 square feet). A typical 800 Lumens projector would have a brightness of 30 Lumens/square foot for an image that covers 27 square feet (for a 7.5 foot diagonal). A typical television picture has a brightness of about 20-30 Lumens/square foot.

FIG. 3 shows a prior approach 300 which uses a laser 302 light source, with a beam 303 impacting a rotating polygon mirror providing horizontal deflection. The deflected beam 305 impacts an oscillating galvanometer mirror providing vertical deflection 306. The beam 307 then goes through a projection lens 308, emerges as beam 309 and impacts screen 310. This approach may be expensive due to the components involved.

Thus all these displays present a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be implemented;

FIG. 2 is a block diagram of a computer system which may be used for implementing some embodiments of the invention;

FIG. 3 shows a prior approach;

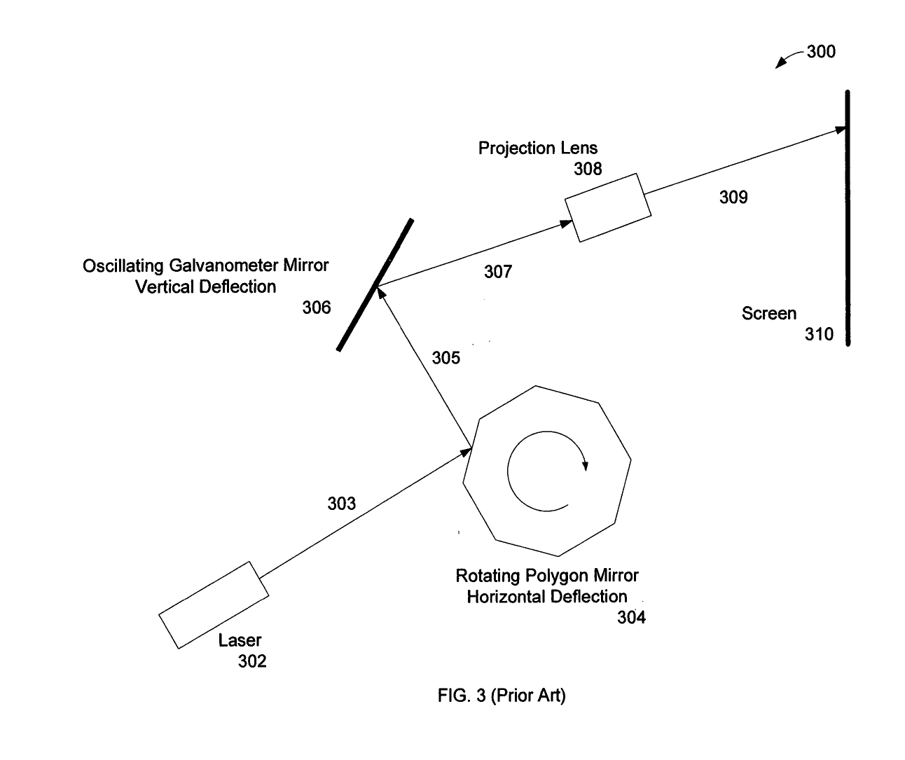

FIG. 4 illustrates one embodiment of the invention showing a projected image;

FIG. 5 illustrates one embodiment of the invention showing a cross-section of one embodiment of a projector;

FIG. 6 illustrates one embodiment of the invention in a system block diagram form;

FIG. 7 illustrates one embodiment of the invention showing substrate details and N×1 LED horizontal arrays;

FIG. 8 illustrates one embodiment of the invention showing the creation of an M×N display using a vertical motion;

FIG. 9 illustrates one embodiment of the invention showing timing of and energizing of LEDs;

FIG. 10 illustrates one embodiment of the invention showing the creation of an M×N display using a horizontal motion;

FIG. 11 illustrates another embodiment of the invention; and

FIG. 12 illustrates one embodiment of the invention in flow chart form.

### DETAILED DESCRIPTION

This design, as exemplified in various embodiments of the invention, illustrates how light emitting devices may be used to create a display. There are a variety of light emitting devices, for example, light emitting diodes (commonly referred to as LEDs), visible light emitting lasers, vertical cavity surface emitting lasers (VCSELs), quantum dots, resonant cavity light emitting diodes (RCLEDs), etc. For convenience in illustrating various embodiments of the invention, LED and similar terms will refer to all such Light Emitting Devices, not to just light emitting diodes. That is, our use of LED here includes, light emitting diodes, lasers, etc. Where a distinction is made the text will explicitly use a specific term intended.

The invention may be used, in one embodiment, to create compact electronic display devices. In another embodiment the display may exhibit low power. Small portable and low power electronic devices may be of benefit for use in industrial, military, commercial, consumer applications, etc. In another embodiment of the invention, a portable projection device may be created to display images.

The invention, in one embodiment, does not use spatial light modulators. It uses a single line of red, green and blue LEDs mounted on a substrate. The substrate is moved in a path at a velocity to scan a whole frame, in for example, 1/85th of a second and the LEDs are driven (also called modulated, pulsed, or fired) to produce the appropriate brightness in the red, green, and blue spectral lines.

In one embodiment of the invention the red, green, and blue array lines are slightly displaced in space and allowance is made for firing the appropriate color LEDs displaced in time to create a final image where the final color is spatially correct. The display controller ensures that the right (for example, intensity) information for the red, green, and blue pixels is used to drive the LED arrays at the appropriate time taking into account the spatial displacements of the red, green, and blue LEDs.

Additionally, in another embodiment, the driving and time wear characteristics of the LEDs are accounted for so as to achieve a display of more uniform brightness and color balance over time.

In one embodiment, the present invention may be used to create a projection display. One use is a display projected on a flat working surface such as a desk or table, or onto a sheet of white paper. The image is roughly 35-45 cm away from the eyes of the user. In one implementation of the invention, an image of 800×600 pixels (SVGA resolution) is created to occupy an area that is approximately 8″ by 6″. This implies a pixel density of approximately 100 dots per inch and at 40 cm an angular field of view of about 30 degrees. This is good for the viewer because although the human eye can see over a field of view of approximately 100 degrees, beyond about 15 degrees from the center of the field the resolution degrades significantly. The image size at 8″ by 6″ has an area of ⅓ square foot. Thus a light output of 10 Lumens will give a brightness of 30 Lumens/square foot. The luminous efficiency of LEDs has been improving steadily over the last few years. Luminous efficiencies may vary over the spectrum; however, a composite number of about 30 Lumens/W can be achieved today. Thus it is possible to build a portable LED based projection display system that will dissipate 3-5 watts allowing for all the losses, conversion inefficiencies as well as energy required for the motion system.

Thus a method and apparatus for a light emitting devices based display have been described.

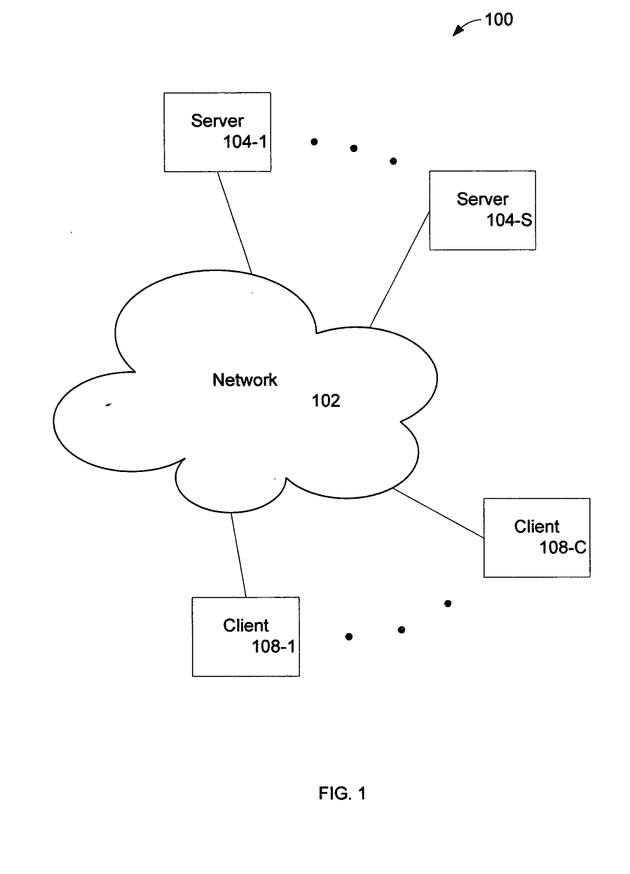

FIG. 1 illustrates a network environment 100 in which the techniques described may be applied. The network environment 100 has a network 102 that connects S servers 104-1 through 104-S, and C clients 108-1 through 108-C. More details are described below.

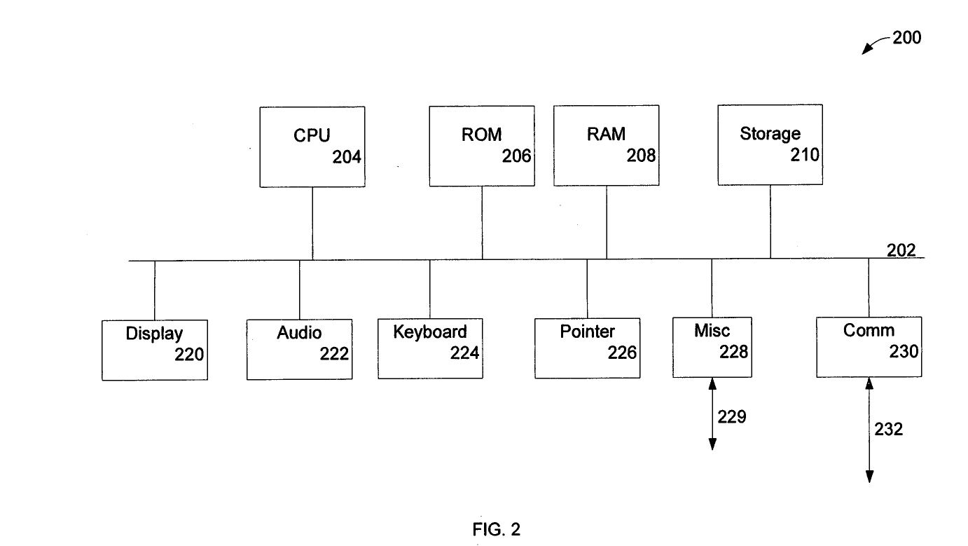

FIG. 2 illustrates a computer system 200 in block diagram form, which may be representative of any of the clients and/or servers shown in FIG. 1, as well as, devices, clients, and servers in other Figures. More details are described below.

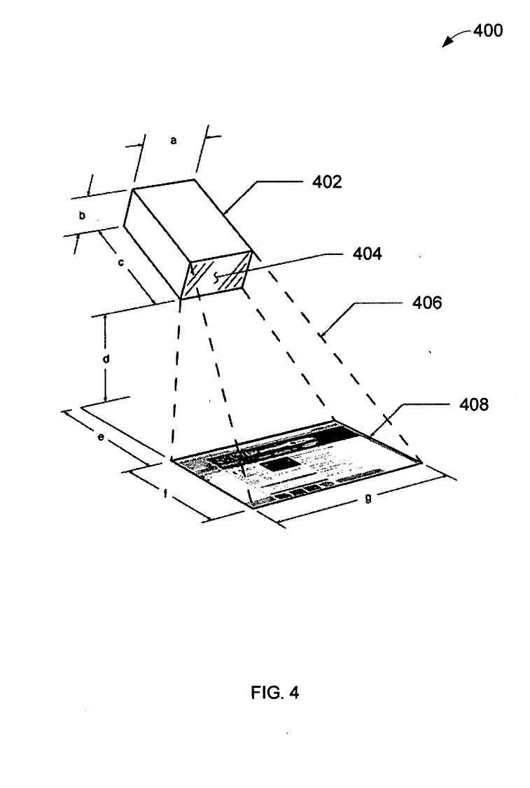

FIG. 4 illustrates one embodiment of the invention 400. 402 is a housing containing a LED display projection system which projects an image through a window 404 which expands in size as shown by dashed lines such as 406 to an image displayed at 408. In one embodiment of the invention, Keystone correction is employed to provide a projection on a surface that does not suffer from the keystone effect. In one implementation, as shown in FIG. 4, the dimensions may be for example, b equal to 5 cm, a equal to 7.5 cm, c equal to 25 cm, d equal to 15 cm, f equal to 15 cm, and g equal to 20 cm. In other embodiments the keystone correction may be coupled with intensity compensation so the image projected is of equal brightness across the full image projected onto a surface.

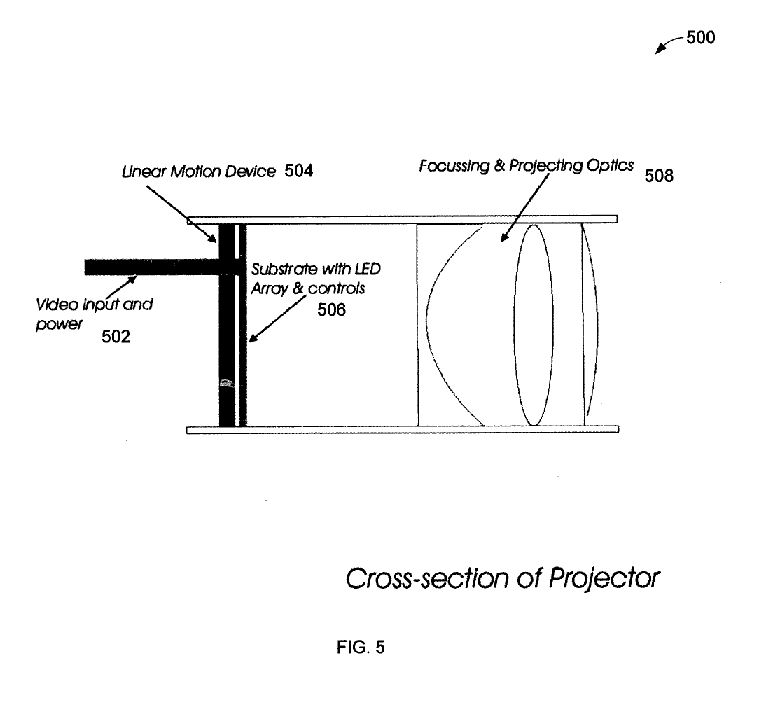

FIG. 5 illustrates another embodiment of the invention 500. A cross-section of one embodiment of a projector is shown. At 502 is a video input and power input. At 504 is a linear motion device. At 506 is a substrate with an LED array and controls. The substrate provides the physical support to the LED array (IR LED, VCSEL, etc.) so that the array is located in a precise position. In addition, electrical connections are made to the LEDs from the driver and control electronics integrated circuits, which may be attached (for example, bonded) to the substrate. A material with good thermal conduction properties may be chosen for the substrate to efficiently conduct the heat dissipated in the LEDs and electronics. At 508 are optics for focusing and projecting an image.

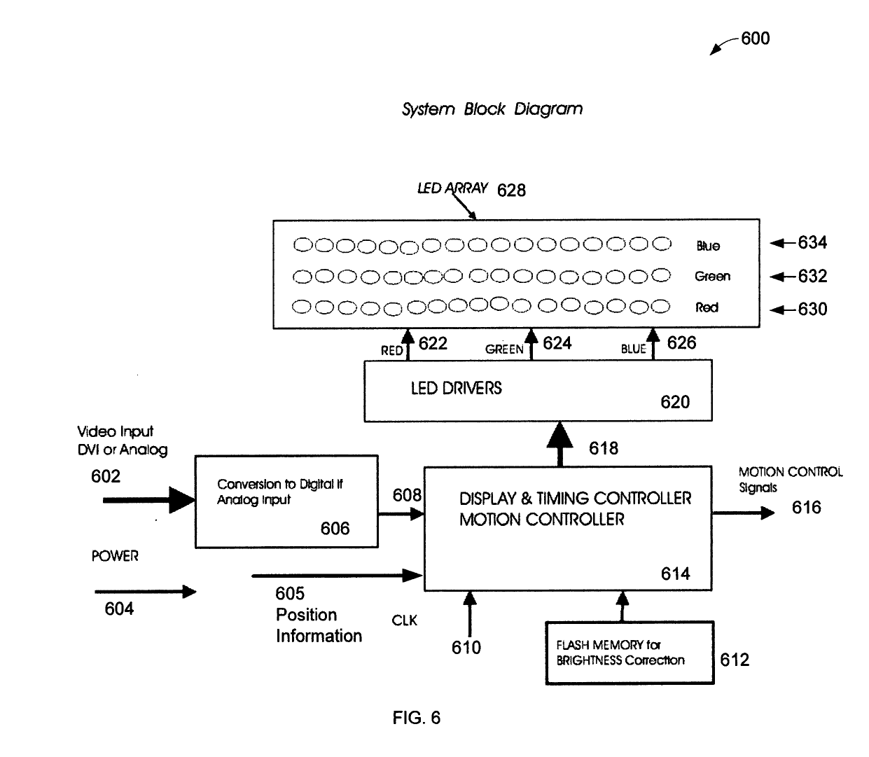

FIG. 6 illustrates one embodiment of the invention 600 showing a system block diagram. At 602 is a video input which may consist of a variety of input signal formats, for example, DVI, analog, etc. At 604 is a power input. At block 606 conversion to a digital format is performed. This conversion is generally necessary for analog input signals. In other embodiments, the digital video input may need to be reformatted into a format which is acceptable for the display and timing controller and motion controller shown at 614. The output of block 606 is communicated via link 608 to the display and timing controller and motion controller indicated at 614. 614 also takes as input a clock as indicated at 610 and flash memory signals for brightness correction, or other correction factors, as indicated at 612. A position signal indicated by 605 provides position feedback information that is provided by an external detector triggered by the IRLED or VCSEL energized from the substrate. Two output signals are provided from the display and timing controller and motion controller of 614, these are output signal 616 which is a motion control signal and 618 which go to the LED drivers indicated at 620. In one embodiment of the invention, the LED drivers drive three different colored LEDs, red 622, green 624, and blue 626. In this embodiment, the LED array of 628 is shown with three rows of LEDs each row being a single color; red at 630, green at 632, and blue at 634.

In other embodiments of the invention the LED drivers may drive different colored LEDs or different numbers of LEDs. Additionally the LED array may not consist of rows of single color LEDs but may consist of, for example, rows interposed of different colored LEDs. One of skill in the art will appreciate that from a fabrication and design standpoint, a variety of different possibilities are available and may be beneficial.

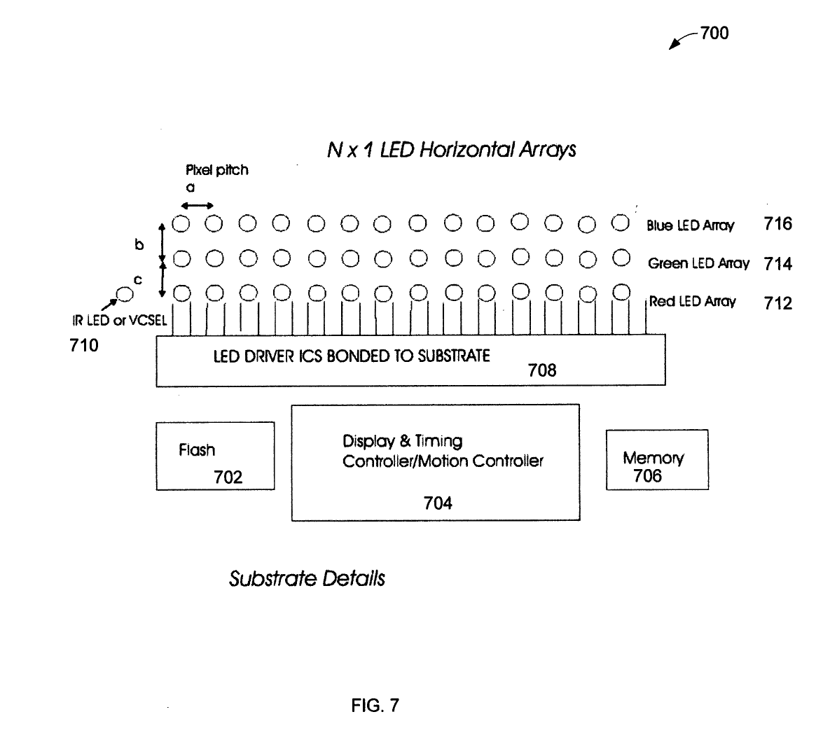

FIG. 7 illustrates one embodiment of the invention 700 showing substrate details and an N×1 LED horizontal arrays. At 704 is a display and timing controller and motion controller which interacts with flash memory 702, memory 706, and LED driver 708. LED driver 708 additionally interfaces with an infrared LED at 710 and three rows of LED arrays of different colors; red at 712, green at 714, and blue at 716. As illustrated in FIG. 7, a is the horizontal pixel pitch for each of the rows of LEDs, b is the spacing between the blue and green rows of LEDs, and c is the spacing between the green and red rows of LEDs. In one embodiment of the invention, microlenses may be fabricated or placed on top of each of the LEDs, which may lead to a higher perceived flux output for each of the LEDs and may reduce cross-talk between the devices.

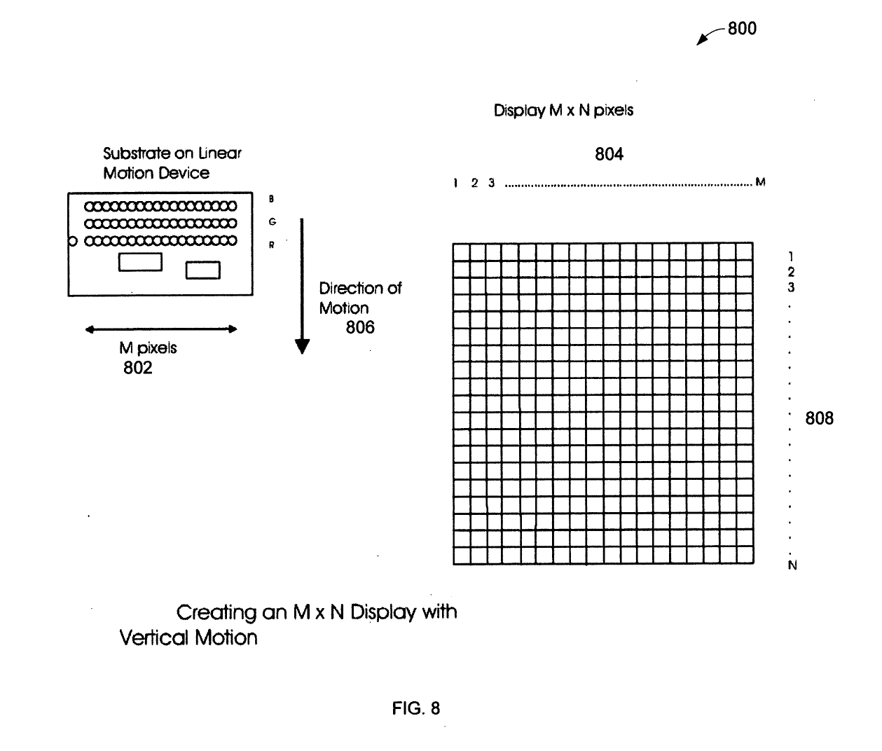

FIG. 8 illustrates one embodiment of the invention 800 showing the creation of an M×N display using a vertical motion. Here, at 802 is a device having a row of M pixels moving in a direction indicated by the arrow at 806. The resulting display is M×N pixels as indicated at 804 and 808 respectively. In one embodiment of the invention, the display resolution of M×N pixels is determined in the M dimension by the number of pixels on a substrate, and the number of pixels in the N dimension is determined by the length of travel in the direction of motion and the number of times that the pixels may be energized along this length of travel. The spacing of the pixels in the N dimension is determined by the velocity of travel in a direction as well as the timing of driving the M pixels. In another embodiment of the invention, the pixels in the M dimension may be perceptively increased by “jogging” (for example, in a horizontal motion) the fixed “pixels” creating an apparent increase in resolution.

In one embodiment of the invention, as illustrated in FIG. 8, the direction of the motion of the M pixels 802 is in a single direction as indicated by arrow 806. For a repetitive display, in one embodiment, the M pixels 802 may be spinning on an axis parallel to the array. In this embodiment, the display may be seen from a variety of angles as the M pixels 802 spin in a circular path. Controlling when the M pixels 802 are illuminated will then determine from which viewing angle the display may be seen.

In one embodiment of the invention, as illustrated in FIG. 8, the direction of the motion of the M pixels 802 may initially be in the direction as indicated by arrow 806, and then it may reverse direction and travel in the direction opposite that as indicated at 806. In this embodiment then, the M pixels 802 will “shuttle” back and forth to create the M×N pixel display.

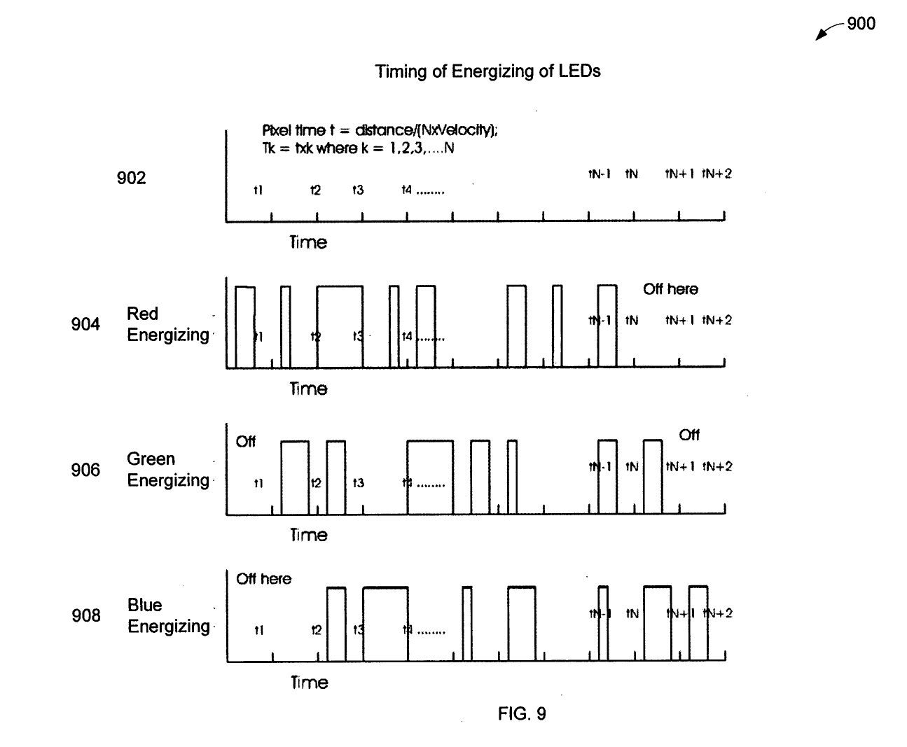

FIG. 9 illustrates one embodiment of the invention 900 showing timing of and energizing (also called modulating, firing, or driving) of LEDs. At 902 is a time template for illustrating the timing of energizing of LEDs. At 904 is shown timing and energizing of red LEDs, the time ON is indicated by the presence and width of a vertical bar while the OFF time has no such bar. At 906 is illustrated green and at 908 is illustrated blue LED timing. One of skill in the art will recognize this modulation as pulse width modulation (PWM). In other embodiments, other forms of modulation may be used, for example, pulse position modulation, pulse amplitude modulation, etc.

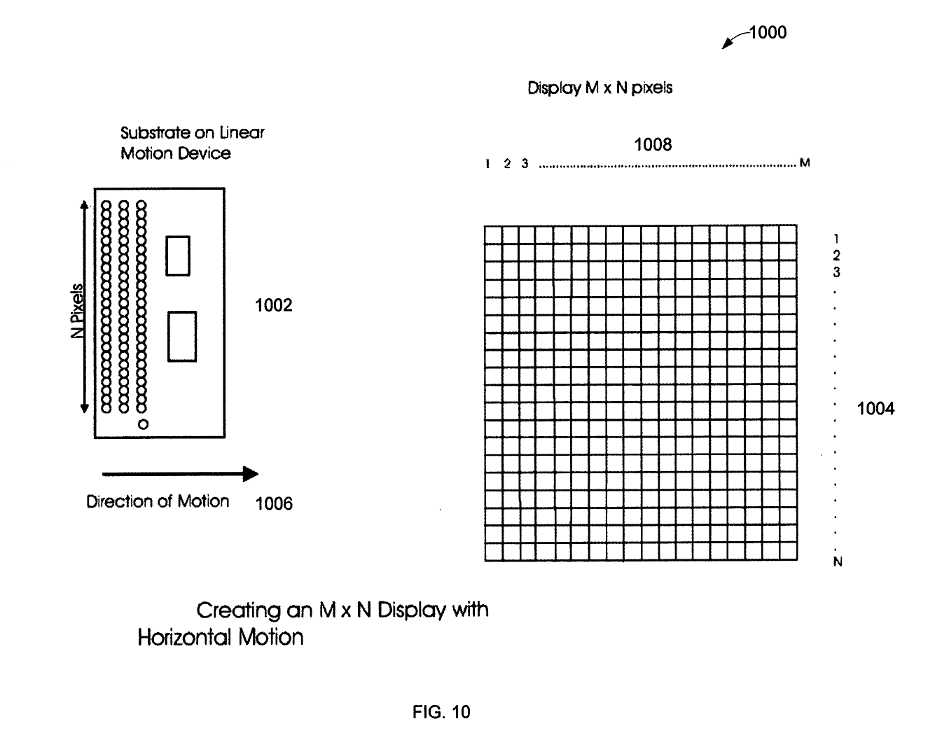

In another embodiment of the invention 1000, as illustrated in FIG. 10, an M×N display is created using horizontal motion. A vertical array of N pixels 1002 is moved in a direction 1006. The resulting display of M×N pixels, M dimension 1008, and N dimension 1004 may be realized. The N dimension pixels spacing is based upon the pixels spacing on the substrate 1002 in the absence of any jogging of the array 1002 in the vertical dimension. The pixel resolution M 1008 in the horizontal dimension is based upon the timing and firing of the LEDs on the substrate 1002 as it is moved in a direction indicated by 1006.

In one embodiment of the invention, as illustrated in FIG. 10, the direction of the motion of the N pixels 1002 is in a single direction as indicated by arrow 1006. For a repetitive display, in one embodiment, the N pixels 1002 may be spinning on an axis parallel to the N pixels 1002. In this embodiment, the display may be seen from a variety of angles as the N pixels 1002 spin in a horizontal circular path. Controlling when the N pixels 1002 are lighted will then determine from which viewing direction the display may be seen.

In one embodiment of the invention, as illustrated in FIG. 10, the direction of the motion of the N pixels 1002 may initially be in the direction as indicated by arrow 1006, and then the N pixels 1002 may reverse direction and travel in the direction opposite that as indicated at 1006. In this embodiment then, the N pixels 1002 will “shuttle” back and forth horizontally to create the M×N pixel display.

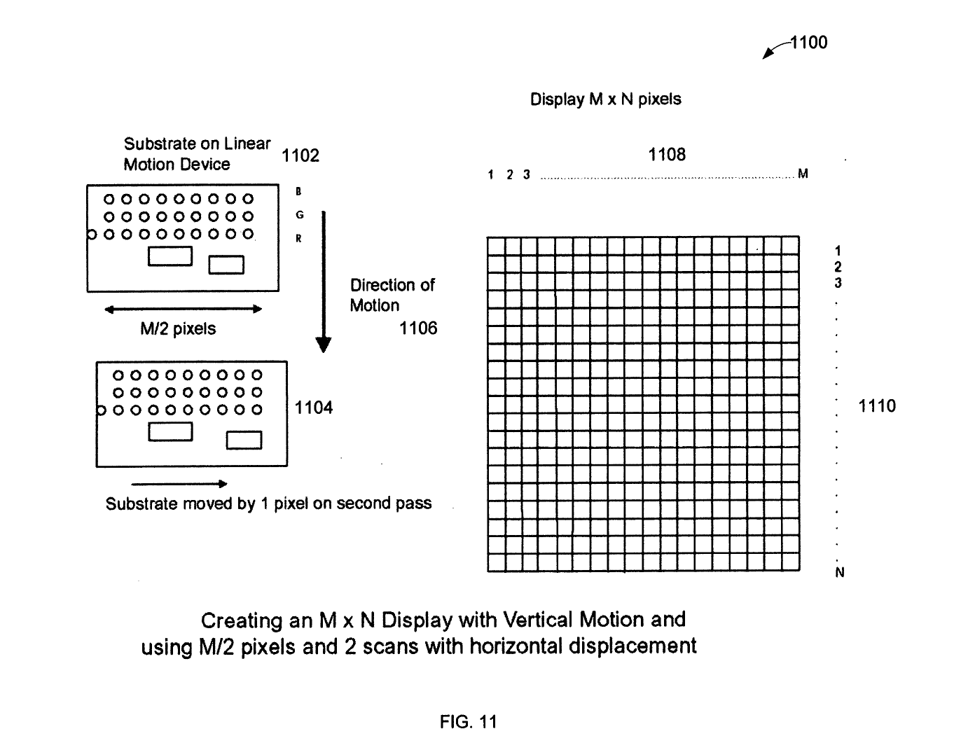

FIG. 11 illustrates another embodiment 1100 of the invention. In this illustration, a substrate 1102 is moved in a direction indicated by 1106 to create a display on a first pass. On a second pass the substrate 1104 is moved over as indicated by the arrow one pixel. In this way, by making multiple passes, fewer LEDs (such as M/2) may be needed on a substrate. The resulting display of M×N pixels is illustrated in the M dimension at 1108 and in the N dimension by 1110. In yet another embodiment, the number of pixels on the substrate may be reduced further by increasing the number of passes required to create the display.

In one embodiment of the invention, as illustrated in FIG. 11, the direction of the motion of the M/2 pixels 1102 is in a single direction as indicated by arrow 1106. For a repetitive display, in one embodiment, the M/2 pixels 1102 may be spinning on an axis parallel to the M/2 pixel array. In this embodiment then, the display may be seen from a variety of angles as the M/2 pixels 1102 spin in a vertical circular path. Controlling when the M/2 pixels 1102 are driven and thus illuminated will then determine from which viewing angle the display may be seen.

In one embodiment of the invention, as illustrated in FIG. 11, the direction of the motion of the M/2 pixels 1102 may initially be in the direction as indicated by arrow 1106, and then it may reverse direction and travel in the direction opposite that as indicated at 1106. In this embodiment then, the M/2 pixels 1102 will “shuttle” back and forth vertically to create the M×N pixel display.

One of skill in the art will appreciate that creating a M×N pixel display with M/2 LEDs is a special case of the more general approach of using M/J LEDs where J is an integer greater than zero, which represents embodiments of the present invention. J then represents the number of “passes” need to construct the M×N display (i.e. (M/J)(J)×N=M/N). One of skill in the art will appreciate that when J is greater than one, the array of LEDs needs to be positioned to intermediate positions (generally equidistant) on subsequent passes so that a uniform M×N display is produced. For example, if M/2 LEDs are used, then on pass 1 the M/2 LED array may have an initial offset perpendicular to the direction of motion of zero. On pass 2 the M/2 LED array may have an offset perpendicular to the direction of motion of ½ the distance between individual LEDs in the LED array. On pass 3 the offset may be that of pass 1, on pass 4 the offset of pass 2, with this repeating. For the general case J the additional offset on subsequent passes would be 1/J the distance between individual LEDs in the LED array for J passes needed to construct the M×N display using M/J LEDs in the LED array.

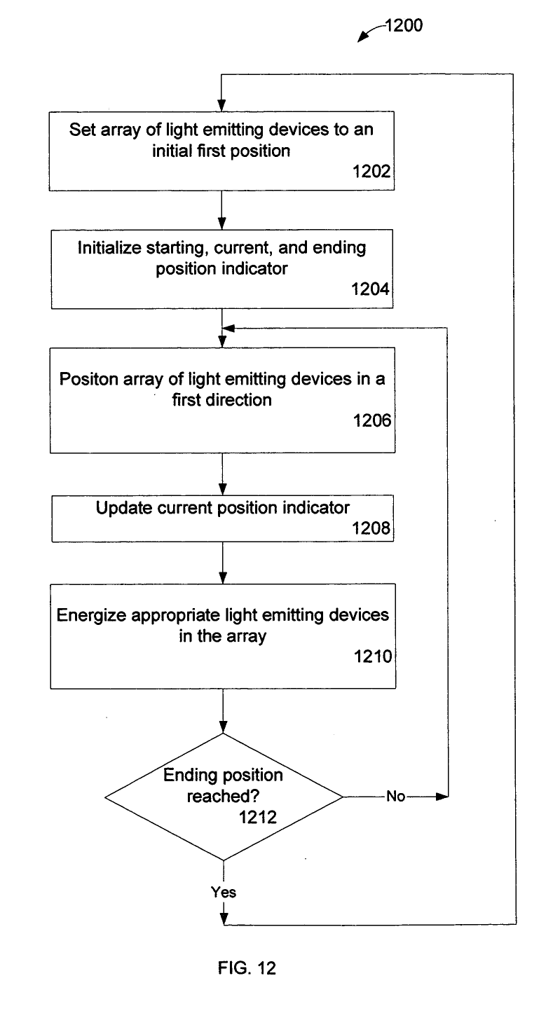

FIG. 12 illustrates one embodiment 1200 of the invention in flow chart form. At 1202 the array of light emitting devices (LEDs) is set to a first initial position. At 1204 indicators for the starting, current, and ending position are initialized. At 1206 the array of LEDs is positioned in a first direction. At 1028 the current position of the LED array is updated and at 1210 the appropriate LEDs in the array are energized to produce light. At 1212 a determination is made as to whether the LED array has reached an ending position. If an ending position has not been reached, then the array is positioned again 1206, position noted 1208, and LEDs energized 1210. If an ending position has been reached then the process repeats at 1202.

In one embodiment of the invention, an initial first position as indicated at 1202 may be at one end of a linear movement stage and the ending position may be at the opposite end of the linear movement stage. In this embodiment the array may traverse from one end to another at a substantially constant velocity and then return to the initial starting position more rapidly (much like a retrace).

In another embodiment of the invention, an initial first position as indicated at 1202 may be at one end of a linear movement stage and the ending position may be the same position. In this embodiment, the array may traverse from one end to the other and then return to the initial starting position so that it travels at a substantially constant linear velocity back and forth (excepting when changing positions at the ends when reversing direction).

One of skill in the art will appreciate that the use of the terms horizontal or vertical are used to describe the invention and are not to be understood as to limit the invention to operating at only a horizontal or vertical position. The invention in other embodiments may operate at any angle of orientation. For example, a display may be operated at a diagonal (i.e. 45 degrees). By controlling when pixels are driven will determine the type of image displayed.

In other embodiments of the invention, the motion, rather than being purely a vertical or horizontal motion may be a motion that is a combination of these, elliptical, or feature a rotating array of LEDs. Combinations of one or more arrays of LEDs may also be used. For example, in one embodiment, two arrays of LEDs may be arranged, one horizontally oriented and in front of another vertically oriented and both arrays may be operating at the same time. What is to be appreciated is that by physically moving the light source such as LEDs, and controlling when they light up, a display may be created which to the human eye appears as an M×N display of pixels. Thus we have a multitude of LEDs that are moved in a controlled manner. The LEDs are energized at the appropriate time and synchronized with the motion to “paint” a picture that may be “magnified” and projected.

In other embodiments of the invention, the linear motion, rather than being substantially constant when producing a display, for example, an M×N display, may vary. One of skill in the art will appreciate that knowing the position of the LED array and the velocity of the LED array and properly energizing the LEDs can produce a variety of effects. For example, compression and/or expansion in different areas of an M×N image are possible. For example, if the firing rate of the LEDs is kept constant and the LED array velocity is increased, an image will appear to stretch. Likewise if the firing rate of the LEDs is constant and the distance per unit time of the LED array is less then nominal, an image will appear to be smaller along the direction of travel of the LED array. A combination is also possible in a single M×N display where the velocity may be above nominal, nominal, and below nominal. One of skill in the art will appreciate that the same “effect” may be achieved by having a substantially nominal velocity and controlling the timing of the firing of the LEDs in the LED array.

In yet another embodiment of the invention, a compact light emitting diode based projection system is provided. It consists of a linear array of red, green, and blue light emitting diodes mounted on a substrate. The substrate also contains electronic circuitry mounted on it, as well as, electronic and mechanical sensing devices. The electronic circuitry is used to drive the light emitting diode arrays at the appropriate times and with the appropriate power levels. The substrate is mounted on a linear motor (for example, a DC electric motor, a linear piezoelectric motor, etc.) or a linear stepper motor or the shaft of a servo-controlled motor. The controller in the system physically moves the substrate in a straight line (for example, back and forth) and in a controlled manner to create an image. Projection optics (lenses) provide magnification and focus the image formed by the light emitting diodes onto a flat surface. The image is formed line by line at high speeds so that the entire image is formed, in one embodiment, in 1/85th of a second. The image information is conveyed to the system through a connection to the outside (Computer, PDA, or other display driver) and is connected to the substrate through a flexible cable. A controller on the substrate provides the synchronized timing and control of the linear motion device.

For illustration purposes, the present invention has been described with respect to a display that is visible to a human. However, other embodiments of the invention may create a display that is not visible to humans. For example, an array of IR (infrared) LEDs might create a display that is not visible to a human but is visible to a video camera sensitive in this spectral region. Other embodiments of the invention may be used to expose, for example, resins, polymers, or other materials to a display which might result in, for example, their hardening in areas exposed to the display and not hardening in other areas. One of skill in the art is to appreciate that the method and apparatus of the present invention may be used for creating an M×N display of energy in a variety of spectral ranges.

Additionally, for illustration purposes, the present invention has been described with “projector” optics. For example, FIG. 4 shows “projecting” from a small array to a larger image, however the invention is not limited to enlarging the image. The display image may be the same size as the array or “reduced” in size as well. For example, to create a very high resolution in an imaging resist, the display created by the array may be optically reduced to a smaller size.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of visual communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220 (for example, embodiments of the present invention), audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for a light emitting devices based display have been described.

1. A method comprising:
(a) positioning an array of light emitting devices (LEDs) in a first position;
(b) moving said array of LEDs;
(c) determining if said array of LEDs are in a given position;
(d) receiving an input display signal;
(e) energizing one or more LEDs in said array of LEDs;
(f) sensing if said array of LEDs is at an end position; and
(g) if not at said end position repeating (b) through (f); and
if at said end position repeating (a) through (f).

2. The method of claim 1 wherein said positioning and moving further comprises a linear motion.

3. The method of claim 1 wherein said energizing is based upon said received input display signal;

4. The method of claim 1 wherein said array further comprises an array of substantially red light emitting diodes, an array of substantially green light emitting diodes, and an array of substantially blue light emitting diodes.

5. The method of claim 4 further comprising focusing any light emitted from said red, green, and blue light emitting diodes on a projection surface.

6. The method of claim 1 further comprising M said light emitting devices and N said given positions and said method of claim 1 is capable of producing an M×N display.

7. A machine-readable medium having stored thereon instructions, which when executed performs the method of claim 1.

8. A system comprising a processor coupled to a memory, which when executing a set of instructions performs the method of claim 1.

9. The method of claim 1 further comprising communicating a payment and/or credit.

10. An apparatus comprising:
a linear movement stage;
a substrate mounted to said linear movement stage;
an array of light emitting devices (LEDs) attached to said substrate; and
a controller attached to said substrate.

11. The apparatus of claim 10 wherein said linear movement stage is capable of movement in one or more directions.

12. The apparatus of claim 10 wherein said linear movement stage is capable of movement back and forth.

13. The apparatus of claim 10 wherein said controller is coupled to control illumination of zero or more LEDs of said array of LEDs.

14. The apparatus of claim 13 wherein said controller is coupled to control positioning of said linear movement stage.

15. The apparatus of claim 10 wherein said linear movement stage further comprises one or more substantially parallel rails.

16. An apparatus for creating a display comprising:
means for positioning an array of light emitting devices (LEDs);
means for energizing zero or more LEDs of said array of LEDs; and
means for focusing any light from said energized zero or more LEDs.

17. The apparatus of claim 16 further comprising means for compensating for wear associated with said LEDs.

18. The apparatus of claim 16 further comprising means for compensating for wear associated with said means for positioning.

19. The apparatus of claim 16 wherein said means for positioning comprises means for positioning in a substantially circular path.

20. The apparatus of claim 16 further comprising means for producing an M×N display using M LEDs in said array of LEDs and N positions.

21. The apparatus of claim 16 further comprising means for producing an M×N display using M/2 LEDs in said array of LEDs and N positions.

22. The apparatus of claim 16 further comprising means for producing an M×N display using M/J LEDs in said array of LEDs and N positions where J is an integer greater than zero.

23. The apparatus of claim 20 further comprising creating said M×N display substantially 24 to 170 times per second.

24. A machine-readable medium having stored thereon information representing the apparatus of claim 16.

25. An apparatus comprising:
a first linear movement stage mounted on one or more rails oriented in a first direction;
a platform mounted to said first linear movement stage;
a second linear movement stage mounted on one or more rails oriented in a second direction attached to said platform;
a substrate mounted to said second linear movement stage; and
an array of light emitting devices (LEDs) attached to said substrate.

26. The apparatus of claim 25 wherein said first direction and said second direction are substantially at a right angle.

27. The apparatus of claim 25 further comprising:
a first moving means attached to said first linear movement stage; and
a second moving means attached to said second linear movement stage.

28. The apparatus of claim 27 wherein said second moving means is mounted on said platform.

29. The apparatus of claim 25 further comprising one or more lenses in optical communication with said array of LEDs.

30. A system for displaying an image comprising:
means for receiving a display signal;
means for positioning an array of light emitting devices (LEDs);
means for determining a precise location of said array of LEDs;
means for energizing one or more LEDs of said array of LEDs based upon said display signal; and
means for optically conveying light from said energized one or more LEDs.

31. A display apparatus comprising:
a plurality of movable optical sources capable of producing an optical output;
a lens capable of receiving and projecting the optical output.

32. The display apparatus of claim 31 where said lens further comprises a plurality of lenses.

33. The display apparatus of claim 32 wherein some of said plurality of lenses is a group of microlenses in substantially close physical proximity to and optically coupled to one or more of said plurality of movable optical sources.

34. The display apparatus of claim 33 wherein some of said plurality of lenses are lenses associated with a projection lens system for projecting said optical output onto a viewable surface.

35. The display apparatus of claim 34 wherein said viewable surface is selected from the group consisting of a flat surface, a retinal surface, and a semi-transparent optical surface.

36. A method for producing an M×N display, the method comprising:
moving a row of substantially linearly spaced M elements capable of light production to N positions; and
energizing one or more of said M elements to produce said light production at one or more of said N positions.

37. A method for producing an M×N display, the method comprising:
moving M elements capable of light production to N positions; and
energizing one or more of said M elements to produce said light production at one or more of said N positions.

38. The method of claim 37 wherein said moving further comprises moving at substantially a non-constant velocity.

39. The method of claim 37 wherein said energizing further comprises energizing at substantially a non-constant time interval.

40. The method of claim 37 wherein said moving further comprises moving in a substantially non-linear direction.
